(19) United States
(12) Patent Application Publication
(10) Pub. No.: US 2022/0103508 A1
(43) Pub. Date: Mar. 31, 2022

(54) INFORMATION PROCESSING APPARATUS AND INFORMATION PROCESSING METHOD

(71) Applicant: TOSHIBA TEC KABUSHIKI KAISHA, Tokyo (JP)

(72) Inventor: Junya MASUMURA, Shizuoka Shizuoka (JP)

(73) Assignee: TOSHIBA TEC KABUSHIKI KAISHA, Tokyo (JP)

(21) Appl. No.: 17/348,881

(22) Filed: Jun. 16, 2021

(30) Foreign Application Priority Data
Sep. 25, 2020 (JP) 2020-161307

(51) Int. Cl. H04L 12/58

(52) U.S. Cl. CPC H04L 51/28; G06F 3/04842

(57) ABSTRACT

An apparatus includes a processor configured to receive an indication of one or more operator-entered addresses entered into an e-mail by an operator via an input; acquire one or more pre-stored address sets from a storage unit in response to (i) each of the one or more pre-stored address sets including a corresponding pre-stored address that matches each of the one or more operator-entered addresses and (ii) a respective transmitting destination type of each of the one or more operator-entered addresses matching the respective transmitting destination type of the corresponding pre-stored address; display the one or more pre-stored address sets on a display; receive a selection of a respective set of the one or more pre-stored address sets via the input; and update the e-mail to include one or more of the pre-stored addresses of the respective set that are not included in the one or more operator-entered addresses.

### CROSS-REFERENCE TO RELATED APPLICATION

This application is based upon and claims the benefit of priority from Japanese Patent Application No. 2020-161307, filed on Sep. 25, 2020, the entire contents of which are incorporated herein by reference.

### FIELD

Embodiments described herein relate generally to information processing apparatuses and information processing methods.

### BACKGROUND

If a user generates an e-mail, the user inputs an e-mail address for each transmitting destination type (TO, carbon copy (CC), or blind carbon copy (BCC)).

As a technology for supporting the user in inputting the e-mail address, there is a technology for displaying an e-mail address matching characters input by the user as a candidate.

Since inputting an e-mail address depends on a user operation, input errors are likely to occur. In one example, an input error is an excess or deficiency of an e-mail address such as forgetting to input a necessary e-mail address or inputting an unnecessary e-mail address. In another example, an input error is a transmitting destination type error, such as inputting an e-mail address in a wrong transmitting destination type. In many cases, the e-mails are erroneously transmitted due to the input errors.

### DESCRIPTION OF THE DRAWINGS

FIG. 1 is a block diagram illustrating a terminal according to an embodiment;

FIG. 2 is a diagram illustrating an address set database;

FIG. 3 is a screen view illustrating a display example of a mail generation window;

FIG. 4 is a screen view illustrating a display example of a selection candidate list;

FIG. 5 is a screen view illustrating a display example of the selection candidate list;

FIG. 6 is a screen view illustrating a display example of the mail generation window;

FIG. 7 is a screen view illustrating a display example of a confirmation dialog;

FIG. 8 is a screen view illustrating a display example of the confirmation dialog;

FIG. 9 is a screen view illustrating a display example of the confirmation dialog; and

FIG. 10 is a flowchart illustrating a procedure for transmitting an e-mail by the terminal.

### DETAILED DESCRIPTION

The invention is to provide a technique for reducing erroneous transmission of e-mails.

In general, according to one embodiment, there is provided an information processing apparatus including a display control unit and a setting unit. The display control unit displays one or more first address sets including a second address set on a display unit based on the fact that the one or more first address sets including the second address set configured with addresses for respective transmitting destination types set in an e-mail before the transmission exist in the plurality of first address sets configured with the addresses for the respective transmitting destination types stored in a storage unit. The setting unit sets the addresses for the respective transmitting destination types configuring the selected first address set to the e-mail based on the selection of the first address set from among the one or more first address sets displayed on the display unit.

Hereinafter, embodiments will be described with reference to the drawings.

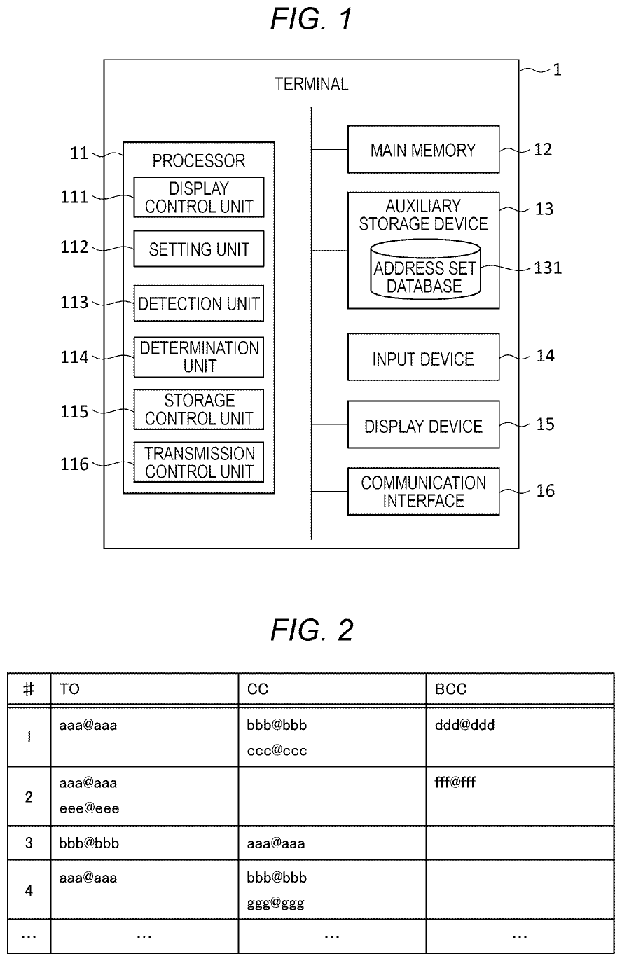

FIG. 1 is a block diagram illustrating a terminal 1. The terminal 1 is a terminal capable of generating an e-mail. The terminal 1 is a personal computer (PC), a tablet terminal, a smartphone, or the like. The terminal 1 is an example of an information processing apparatus.

The terminal 1 is a computer including a processor 11, a main memory 12, an auxiliary storage device 13, an input device 14, a display device 15, and a communication interface 16. The components configuring the terminal 1 are connected to each other so that signals can be input and output. In FIG. 1, an interface is described as “I/F”. In FIG. 1, a database is described as “DB”.

The processor 11 corresponds to a central portion of the terminal 1. For example, the processor 11 is a central processing unit (CPU), but the processor 11 is not limited to thereto. The processor 11 may be configured with various circuits. The processor 11 loads the program stored in advance in the main memory 12 or the auxiliary storage device 13 into the main memory 12. The program is a program that implements each of the components described later in the processor 11 of the terminal 1. The processor 11 executes various operations by executing the program loaded in the main memory 12.

The main memory 12 corresponds to a main memory portion of the terminal 1. The main memory 12 includes a non-volatile memory area and a volatile memory area. The main memory 12 stores an operating system or a program in the non-volatile memory area. The main memory 12 uses the volatile memory area as a work area where data is appropriately rewritten by the processor 11. For example, the main memory 12 includes a read only memory (ROM) as the non-volatile memory area. For example, the main memory 12 includes a random access memory (RAM) as the volatile memory area.

The auxiliary storage device 13 corresponds to an auxiliary storage portion of the terminal 1. For example, the auxiliary storage device 13 is an electric erasable program read-only memory (EEPROM, registered trademark), a hard disk drive (HDD), a solid state drive (SSD), or the like. The auxiliary storage device 13 stores the above-mentioned program, data used by the processor 11 for performing various processes, and data generated by the processes in the processor 11. The auxiliary storage device 13 is an example of a storage unit.

The auxiliary storage device 13 stores an address set database 131. The address set database 131 stores a plurality of first address sets. The first address set is configured with e-mail addresses for transmitting destination types. The transmitting destination types are TO, CC, and BCC. The first address set includes one or more e-mail addresses. Each of the one or more e-mail addresses configuring the first address set is correlated with any one of the transmitting destination types. For example, the first address set is a registered address set configured with e-mail addresses set as transmitting destinations in transmitted e-mails. It is noted that the first address set can be defined in advance based on user operations. The first address set can also be deleted from the address set database 131 based on user operations. The first address set is also referred to as a first transmitting destination set. A combination of the e-mail addresses for the respective transmitting destination types configuring the first address set is also referred to as a first combination or a first designated state. Hereinafter, an e-mail address is also referred to as an address. Hereinafter, the notation of the “plurality of first address sets” may be read as “plurality of first address sets stored in the address set database 131”. The plurality of first address sets are also referred to as accumulated information. A configuration example of the address set database 131 will be described later.

The input device 14 is a device capable of inputting data or an instruction to the terminal 1 by a touch operation. For example, the input device 14 is a keyboard, a touch panel, or the like. The input device 14 is an example of an input unit.

The display device 15 is a device capable of displaying various images under the control of the terminal 1. For example, the display device 15 is a liquid crystal display, an electroluminescence (EL) display, or the like. The display device 15 is an example of a display unit.

The communication interface 16 includes various interfaces that connect the terminal 1 to other devices in a communicable manner via a network according to a predetermined communication protocol. For example, the network is configured with one or more networks such as the Internet, a mobile phone network, or a local area network (LAN).

It is noted that a hardware configuration of the terminal 1 is not limited to the above-described configuration. In the terminal 1, omission and change of the above-mentioned components and addition of new components can be made as appropriate. For example, at least one of the input device 14 and the display device 15 may be a device independent of the terminal 1. Here, at least one of the input device 14 and the display device 15 may be connected to an input/output interface (not illustrated) provided in the terminal 1 by wire or wirelessly.

Each of the components implemented in the above-mentioned processor 11 will be described. The processor 11 implements a display control unit 111, a setting unit 112, a detection unit 113, a determination unit 114, a storage control unit 115, and a transmission control unit 116. Each of the components implemented in the processor 11 can be referred to as a function. It can also be described that each of the components implemented in the processor 11 is implemented in a controller or control unit including the processor 11 and the main memory 12.

The display control unit 111 controls the display device 15 to display various images. The setting unit 112 sets the address as the transmitting destination of the e-mail. The detection unit 113 detects various instructions input by the user with the input device 14. The determination unit 114 processes various determinations. The storage control unit 115 stores the address set in the address set database 131. The transmission control unit 116 performs an e-mail transmission process.

A configuration example of the address set database 131 will be described. FIG. 2 is a diagram illustrating the address set database 131. The address set database 131 includes a “#” item, a “TO” item, a “CC” item, and a “BCC” item. The address set database 131 stores a record for each first address set in which the “#” item, the “TO” item, CC″ item, and the “BCC” item are correlated with each other. The “#” item is an item for setting an identification number that identifies the first address set. The “TO” item is an item for setting one or more addresses correlated with TO among one or more addresses included in the first address set. The “CC” item is an item for setting one or more addresses correlated with CC among the one or more addresses included in the first address set. The “BCC” item is an item for setting one or more addresses correlated with BCC among the one or more addresses included in the first address set.

It is noted that, according to the first address set, one or more addresses may not be set in at least one of CC″ item and the “BCC” item. The address set database 131 can be updated by storing a new first address set by the storage control unit 115.

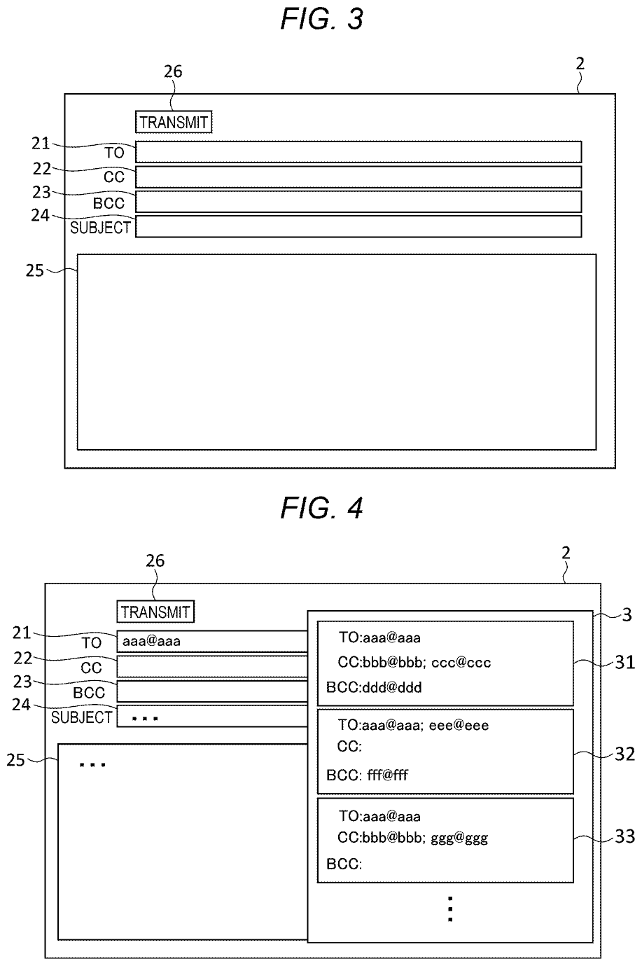

Some image examples displayed by the display device 15 will be described. FIG. 3 is a screen view illustrating a display example of a mail generation window 2. The display control unit 111 allows the display device 15 to display the mail generation window 2 based on a display instruction of the mail generation window 2. The display instruction of the mail generation window 2 is an instruction for displaying the mail generation window 2, which is input by the user with the input device 14. The mail generation window 2 is an example of a display element for generating an e-mail. In some cases, the display element may be a screen.

The mail generation window 2 includes a TO input field 21, a CC input field 22, a BCC input field 23, a subject input field 24, a text input field 25, and a “Transmit” key 26. The TO input field 21 is a field for inputting one or more addresses that become transmitting destinations of which transmitting destination type is TO. The one or more addresses input in the TO input field 21 correspond to one or more addresses of which transmitting destination type is TO, which is set in the e-mail before the transmission. The CC input field 22 is a field for inputting one or more addresses that become transmitting destinations of which transmitting destination type is CC. The one or more addresses input in the CC input field 22 correspond to one or more addresses of which transmitting destination type is CC, which is set in the e-mail before the transmission. The BCC input field 23 is a field for inputting one or more addresses that become transmitting destinations of which transmitting destination type is BCC. The one or more addresses input in the BCC input field 23 correspond to one or more addresses of which transmitting destination type is BCC, which is set in the e-mail before the transmission. The “before the transmission” corresponds to before the transmission control unit 116 completes the e-mail transmission process.

The subject input field 24 is a field for inputting a subject of the e-mail. The text input field 25 is a field for inputting a text of the e-mail. The “Transmit” key 26 is a key for allowing the transmission control unit 116 to start the e-mail transmission process. The selection of the “Transmit” key 26 by the user is an example of a transmission instruction for transmitting the e-mail, which is input by the user with the input device 14.

In some cases, the display control unit 111 may allow the display device 15 to display a newly generated mail generation window 2. In some cases, the display control unit 111 may allow the display device 15 to display the mail generation window 2 for replying to a received mail. Here, one or more addresses are input in advance in the TO input field 21. In some cases, one or more addresses may be input in advance in the CC input field 22.

FIG. 4 is a screen view illustrating a display example of the selection candidate list 3. Herein, it is assumed that the address “aaa@aaa” is input in the TO input field 21. It is assumed that no address is input in the CC input field 22 and the BCC input field 23.

Hereinafter, an address set configured with the addresses for the respective transmitting destination types set in the e-mail before the transmission is also referred to as a second address set. The second address set is configured with the addresses correlated with the respective transmitting destination types. Each of the one or more addresses configuring the second address set is correlated with any one of the transmitting destination types. The second address set is changed according to changes such as deletion or addition of the addresses set in the e-mail before the transmission. The second address set is also referred to as a second transmitting destination set. A combination of the e-mail addresses for the respective transmitting destination types configuring the second address set is also referred to as a second combination or a second designated state. In the example illustrated in FIG. 4, the second address set is configured with “aaa@aaa” correlated with TO.

The display control unit 111 changes whether the selection candidate list 3 which is to be displayed by the display device 15 is necessary depending on whether a first condition is satisfied. The first condition is that one or more first address sets including the second address set exist in the plurality of first address sets. The fact that the first address set includes the second address set denotes that the first address set includes the addresses configuring the second address set for the respective transmitting destination types. It also denotes that all addresses correlated with the respective transmitting destination types configuring the first address set include all addresses correlated with the respective transmitting destination types configuring the second address set.

The fact that the first condition is satisfied corresponds to the fact that one or more first address sets including the second address set exist in the plurality of first address sets. The display control unit 111 allows the display device 15 to display the selection candidate list 3 based on the fact that the first condition is satisfied. The fact that the first condition is not satisfied corresponds to the fact that one or more first address sets including the second address set do not exist in the plurality of first address sets. The display control unit 111 allows the display device 15 not to display the selection candidate list 3 based on the fact that the first condition is not satisfied.

The selection candidate list 3 is a list configured with the one or more first address sets including the second address set. The one or more first address sets configuring the selection candidate list 3 are address sets that are selection candidates. The selection candidate list 3 is superimposed on the mail generation window 2 and displayed in a front plane of the mail generation window 2, but the display mode is not limited thereto. The selection candidate list 3 may be displayed by the display device 15 in a user-visible mode. A display order of the one or more first address sets configuring the selection candidate list 3 may be an order of selection frequency or the like, and the display order is not limited thereto.

In the example illustrated in FIG. 4, the selection candidate list 3 includes a first address set 31, a first address set 32, and a first address set 33.

The first address set 31 corresponds to the first address set identified by #1 exemplified in FIG. 2. The first address set 31 is configured with “aaa@aaa” correlated with TO, “bbb@bbb” and “ccc@ccc” correlated with CC, and “ddd@ddd” correlated with BCC. The address correlated with the TO configuring the first address set 31 includes “aaa@aaa” correlated with TO configuring the second address set exemplified in FIG. 4. Since the first address set 31 includes the second address set, the selection candidate list 3 includes the first address set 31 identified by #1.

The first address set 32 corresponds to the first address set identified by #2 exemplified in FIG. 2. The first address set 32 is configured with “aaa@aaa” and “eee@eee” correlated with TO, and “fff@fff” correlated with BCC. The address correlated with the TO configuring the first address set 32 includes “aaa@aaa” correlated with the TO configuring the second address set exemplified in FIG. 4. Since the first address set 32 includes the second address set, the selection candidate list 3 includes the first address set 32 identified by #2.

The first address set 33 corresponds to the first address set identified by #4 exemplified in FIG. 2. The first address set 33 is configured with “aaa@aaa” correlated with TO and “bbb@bbb” and “ggg@ggg” correlated with CC. The address correlated with the TO configuring the first address set 33 includes “aaa@aaa” correlated with the TO configuring the second address set illustrated in FIG. 4. Since the first address set 33 includes the second address set, the selection candidate list 3 includes the first address set 33 identified by #4.

It is noted that the first address set identified by #3 exemplified in FIG. 2 is configured with “bbb@bbb” correlated with TO and “aaa@aaa” correlated with CC. The address correlated with the TO configuring the first address set does not include “aaa@aaa” correlated with the TO configuring the second address set exemplified in FIG. 4. Both the first address set and the second address set include “aaa@aaa”, but the transmitting destination types to which “aaa@aaa” is associated are different from each other. Since the first address set does not include the second address set, the selection candidate list 3 does not include the first address set identified by #3.

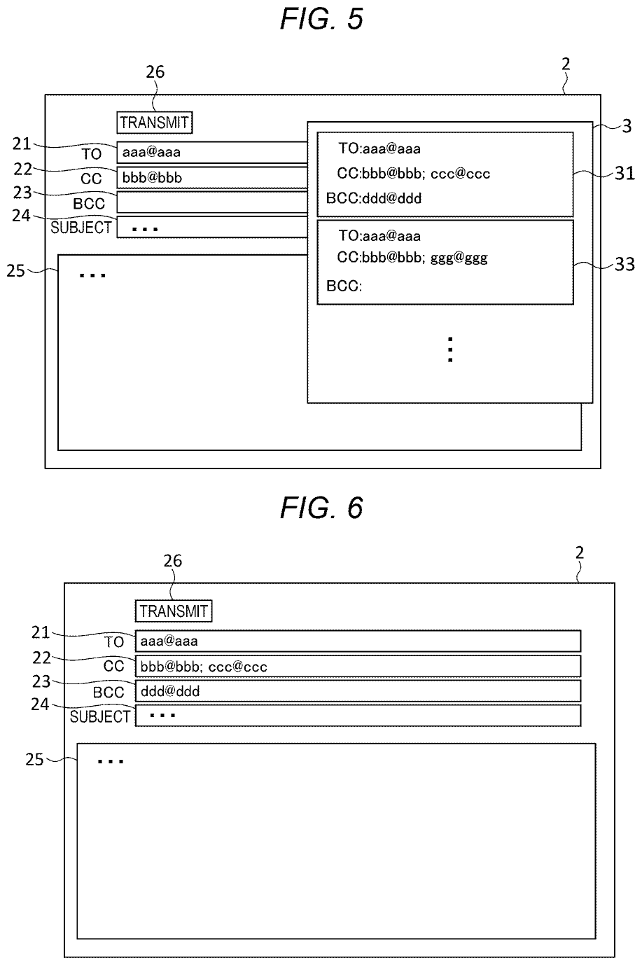

FIG. 5 is a screen view illustrating a display example of the selection candidate list 3. FIG. 5 is a diagram illustrating a state in which the selection candidate list 3 is updated as the user additionally inputs an e-mail address to the e-mail generation window 2 exemplified in FIG. 4.

Herein, it is assumed that “aaa@aaa” is input in the TO input field 21. It is assumed that “bbb@bbb” is input in the CC input field 22. It is assumed that no address is input in the BCC input field 23. In the example illustrated in FIG. 5, the second address set is configured with “aaa@aaa” correlated with TO and “bbb@bbb” correlated with CC.

The display control unit 111 updates the selection candidate list 3 and allows the display device 15 to display the selection candidate list based on the fact that “bbb@bbb” is input to the CC input field 22. The selection candidate list 3 transitions from the state where the first address set 32 is included to the state where the first address set 32 is not included.

The address correlated with the TO configuring the first address set 31 includes “aaa@aaa” correlated with the TO configuring the second address set exemplified in FIG. 5. The address correlated with CC configuring the first address set 31 includes “bbb@bbb” correlated with CC configuring the second address set illustrated in FIG. 5. Since the first address set 31 includes the second address set, the selection candidate list 3 continues to include the first address set 31 identified by #1.

Since the first address set 33 also includes the second address set, the selection candidate list 3 continues to include the first address set 33 identified by #4.

It is noted that no address is correlated with CC configuring the first address set 32 identified by #2. The address correlated with CC configuring the first address set 32 does not include “bbb@bbb” correlated with CC configuring the second address set exemplified in FIG. 5. Since the first address set 32 does not include the second address set, the selection candidate list 3 does not include the first address set 32.

FIG. 6 is a screen view illustrating a display example of the mail generation window 2. FIG. 6 is a diagram illustrating a state after the first address set 31 exemplified in FIG. 5 is selected by the user. The selection of the first address set is the selection of the first address set from among the one or more first address sets configuring the selection candidate list 3. The selection of the first address set is an example of a selection instruction for selecting any first address set, which is input by the user with the input device 14.

The setting unit 112 sets the addresses for the respective transmitting destination types configuring the selected first address set 31 in the e-mail based on the user's selection of the first address set 31. In the present example, the setting unit 112 reflects “aaa@aaa” correlated with TO configuring the first address set 31 to the TO input field 21. The setting unit 112 reflects “bbb@bbb” and “ccc@ccc” correlated with CC configuring the first address set 31 to the CC input field 22. The setting unit 112 reflects “ddd@ddd” correlated with the BCC configuring the first address set 31 to the BCC input field 23. Reflecting includes maintaining the address input in the e-mail generation window 2. Reflecting includes adding an address to an address that is not input in the e-mail generation window 2.

A display example of the confirmation dialog will be described. The confirmation dialog is an example of a notification regarding confirmation of the transmission of the e-mail to be displayed by the display device 15 after the selection of the “Transmit” key 26 by the user and before the transmission of the e-mail. The notification is an example of the display element.

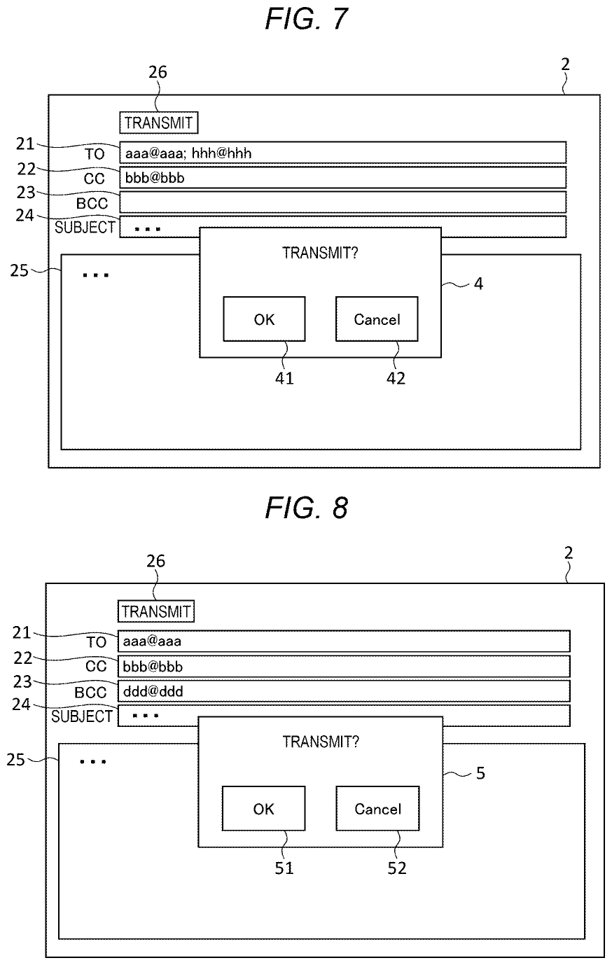

FIG. 7 is a screen view illustrating the display example of the confirmation dialog 4. The confirmation dialog 4 is displayed if the first address set is not selected.

Herein, it is assumed that the user does not select the first address set from among the one or more first address sets configuring the selection candidate list 3. It is assumed that “aaa@aaa” and “hhh@hhh” are input in the TO input field 21. It is assumed that “bbb@bbb” is input in the CC input field 22. It is assumed that no address is input in the BCC input field 23. The second address set is configured with “aaa@aaa” and “hhh@hhh” correlated with TO and “bbb@bbb” correlated with CC. It is assumed that the user selects the “Transmit” key 26 in a state where the above-mentioned second address set is set in the e-mail before the transmission. It is assumed that the one or more first address sets including the above-mentioned second address set do not exist in the plurality of first address sets.

A display condition of the confirmation dialog 4 is the first condition described above. The display control unit 111 changes whether the confirmation dialog 4 is necessary depending on whether the first condition is satisfied. The display control unit 111 allows the display device 15 not to display the confirmation dialog 4 after the selection of the “Transmit” key 26 by the user and before the transmission of the e-mail based on the condition that the first condition is satisfied. The display control unit 111 allows the display device 15 to display the confirmation dialog 4 after the selection of the “Transmit” key 26 by the user and before the transmission of the e-mail based on the fact that the first condition is not satisfied. In the example illustrated in FIG. 7, since one or more first address sets including the second address set do not exist in the plurality of first address sets, the confirmation dialog 4 is displayed.

The confirmation dialog 4 includes a message confirming whether the e-mail can be transmitted. The confirmation dialog 4 includes an “OK” key 41 and a “Cancel” key 42. The “OK” key 41 is a key for enabling the transmission of the e-mail. The “OK” key 41 is also a key for allowing the transmission control unit 116 to continue the e-mail transmission process and allowing the transmission control unit 116 to complete the e-mail transmission process. The selection of the “OK” key 41 is an example of an instruction for enabling the transmission of the e-mail, which is input by the user with the input device 14. The selection of the “OK” key 41 is also an example of an instruction for completing the e-mail transmission process. The transmission control unit 116 continues and completes the e-mail transmission process based on the selection of the “OK” key 41. The display control unit 111 sets the confirmation dialog 4 and the mail generation window 2 to be non-displayed by the display device 15 based on the selection of the “OK” key 41.

The “Cancel” key 42 is a key for disabling the transmission of the e-mail. The “Cancel” key 42 is also a key for allowing the transmission control unit 116 to stop the e-mail transmission process. The selection of the “Cancel” key 42 is an example of an instruction for disabling the transmission of the e-mail, which is input by the user with the input device 14. The selection of the “Cancel” key 42 is also an example of an instruction for stopping the e-mail transmission process. The transmission control unit 116 stops the e-mail transmission process based on the selection of the “Cancel” key 42. The display control unit 111 sets the confirmation dialog 4 to be non-displayed by the display device 15 based on the selection of the “Cancel” key 42. The display control unit 111 allows the display device 15 to display the mail generation window 2 in an inputable state.

The confirmation dialog 4 is superimposed on the mail generation window 2 and displayed in the front plane of the mail generation window 2, but the display mode is not limited to thereto. The confirmation dialog 4 may be displayed by the display device 15 in a user-visible mode.

FIG. 8 is a screen view illustrating a display example of the confirmation dialog 5. The confirmation dialog 5 is displayed if the first address set is selected.

Herein, it is assumed that the user deletes “ccc@ccc” in the CC input field 22 in the e-mail generation window 2 exemplified in FIG. 6, to which the first address set 31 is reflected. As a result, it is assumed that “aaa@aaa” is input in the TO input field 21. It is assumed that “bbb@bbb” is input in the CC input field 22. It is assumed that “ddd@ddd” is input in the BCC input field 23. The second address set is configured with “aaa@aaa” correlated with TO, “bbb@bbb” correlated with CC, and “ddd@ddd” correlated with BCC. It is assumed that the user selects the “Transmit” key 26 in a state where the above-mentioned second address set is set in the e-mail before the transmission.

A display condition of the confirmation dialog 5 is the second condition. The second condition is that the second address set matches the selected first address set. The fact that the second address set matches the first address set denotes that the second address set matches the addresses configuring the first address set for the respective transmitting destination types. It also denotes that all the addresses correlated with the respective transmitting destination types configuring the second address set match all the addresses correlated with the respective transmitting destination types configuring the first address set.

The display control unit 111 changes whether the confirmation dialog 5 which is to be displayed by the display device 15 is necessary depending on whether the second condition is satisfied. The fact that the second condition is satisfied corresponds to the fact that the second address set matches the selected first address set. The display control unit 111 does not display the confirmation dialog 5 by the display device 15 after the selection of the “Transmit” key 26 by the user and before the transmission of the e-mail based on the fact that the second condition is satisfied. The fact that the second condition is not satisfied corresponds to the fact that the second address set does not match the selected first address set. The display control unit 111 allows the display device 15 to display the confirmation dialog 5 after the selection of the “Transmit” key 26 by the user or before the transmission of the e-mail based on the fact that the second condition is not satisfied.

In the example illustrated in FIG. 8, all the addresses correlated with TOs configuring the second address set match all the addresses correlated with the TOs configuring the first address set 31. All addresses correlated with BCCs configuring the second address set match all addresses correlated with BCCs configuring the first address set 31. All addresses correlated with CCs configuring the second address set do not match all addresses correlated with CCs configuring the first address set 31. Specifically, “ccc@ccc” is correlated with CCs configuring the first address set 31 but is not correlated with CCs configuring the second address set. Therefore, the second address set does not match the first address set 31. In the example illustrated in FIG. 8, since the second address set does not match the selected first address set 31, the display control unit 111 allows the display device 15 to display the confirmation dialog 5.

The confirmation dialog 5 includes a message confirming whether the e-mail can be transmitted. The confirmation dialog 5 includes an “OK” key 51 and a “Cancel” key 52. The “OK” key 51 may be the same as the “OK” key 41. The “Cancel” key 52 may be similar to the “Cancel” key 42. The display mode of the confirmation dialog 5 may be the same as that of the confirmation dialog 4.

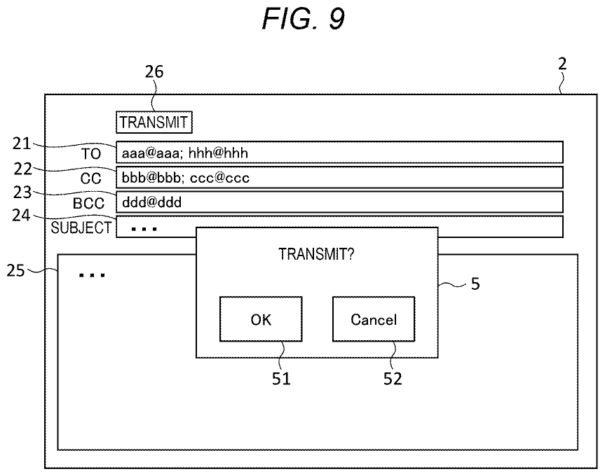

FIG. 9 is a screen view illustrating a display example of the confirmation dialog 5. Herein, it is assumed that the user adds “hhh@hhh” to the TO input field 21 in the e-mail generation window 2 exemplified in FIG. 6, to which the first address set 31 is reflected. As a result, it is assumed that “aaa@aaa” and “hhh@hhh” are input in the TO input field 21. It is assumed that “bbb@bbb” and “ccc@ccc” are input in the CC input field 22. It is assumed that “ddd@ddd” is input in the BCC input field 23. The second address set is configured with “aaa@aaa” and “hhh@hhh” correlated with TO, “bbb@bbb” and “ccc@ccc” correlated with CC, and “ddd@ddd” correlated with BCC. It is assumed that the user selects the “Transmit” key 26 in a state where the above-mentioned second address set is set in the e-mail before the transmission.

In the example illustrated in FIG. 9, all the addresses correlated with CCs configuring the second address set match all the addresses correlated with CCs configuring the first address set 31. All the addresses correlated with BCCs configuring the second address set match all the addresses correlated with BCCs configuring the first address set 31. All the addresses correlated with TOs configuring the second address set do not match all the addresses correlated with TOs configuring the first address set 31. Specifically, with the TOs configuring the second address set, but “hhh@hhh” is correlated with the TOs configuring the first address set 31. Therefore, the second address set does not match the first address set 31. In the example illustrated in FIG. 9, since the second address set does not match the selected first address set 31, the display control unit 111 allows the display device 15 to display the confirmation dialog 5.

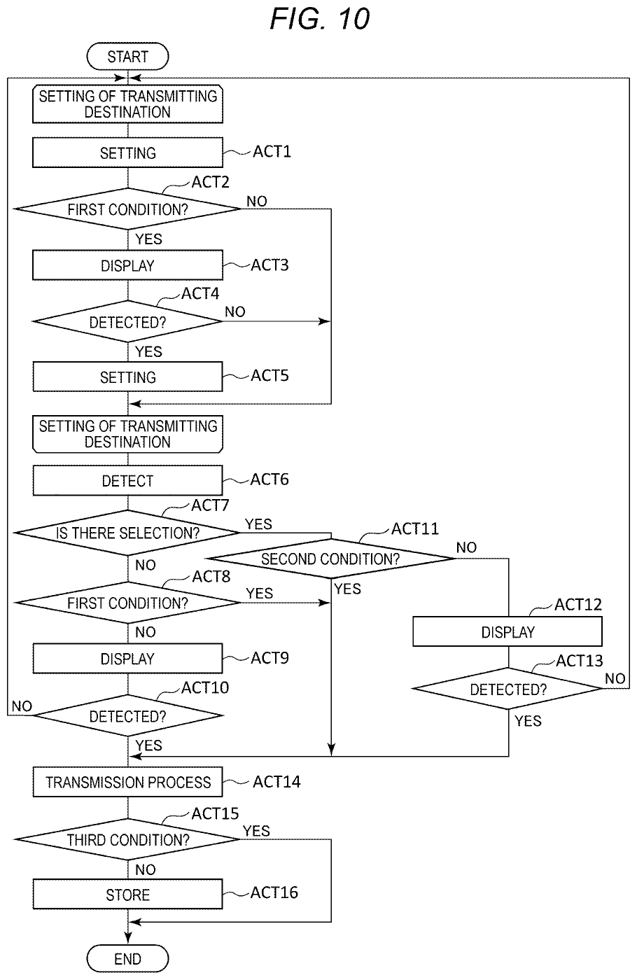

Next, a procedure of the e-mail transmission process by the terminal 1 will be described. FIG. 10 is a flowchart illustrating the procedure of the e-mail transmission process by the terminal 1. It is assumed that the mail generation window 2 is displayed by the display device 15.

It is noted that the process procedure described below is only an example, and each process may be changed as much as possible. With respect to the process procedure described below, steps can be omitted, replaced, and added as appropriate according to the embodiment.

The setting unit 112 sets the address input by the user with the input device 14 as the transmitting destination of the e-mail (ACT 1). In ACT 1, for example, the setting unit 112 sets the address for each transmitting destination type input in the e-mail generation window 2 as the transmitting destination in the e-mail.

The determination unit 114 determines whether the above-mentioned first condition is satisfied (ACT 2). In ACT 2, for example, the determination unit 114 compares the second address set based on the settings in ACT 1 with the plurality of first address sets. The determination unit 114 determines whether the first condition is satisfied based on the comparison. If the determination unit 114 determines that the first condition is satisfied (YES in ACT 2), the process transitions from ACT 2 to ACT 3. The fact that the determination unit 114 determines that the first condition is satisfied is an example of the fact that the first condition is satisfied. If the determination unit 114 determines that the first condition is not satisfied (NO in ACT 2), the process transitions from ACT 2 to ACT 1 or ACT 6 according to the input by the user. The fact that the determination unit 114 determines that the first condition is not satisfied is an example of the fact that the first condition is not satisfied.

The display control unit 111 allows the display device 15 to display the selection candidate list 3 based on the fact that it is detected by the determination unit 114 that the first condition is satisfied (ACT 3). In ACT 3, for example, the display control unit 111 displays the selection candidate list 3 configured with one or more first address sets including the second address set based on the settings in ACT 1.

The detection unit 113 detects the selection of the first address set by the user (ACT 4). In ACT 4, for example, the detection unit 113 detects the selection of the first address set from the selection candidate list 3. The detection unit 113 may temporarily store the identification number of the selected first address set in the main memory 12 or the auxiliary storage device 13 for the process of ACT 7 described later. If the selection of the first address set is detected by the detection unit 113 (YES in ACT 4), the process transitions from ACT 4 to ACT 5. The fact that the selection of the first address set is detected by the detection unit 113 is an example of the fact that the first address set is selected by the user. If the selection of the first address set is not detected by the detection unit 113 (NO in ACT 4), the process transitions from ACT 4 to ACT 1 or ACT 6 according to the input by the user. The fact that the selection of the first address set is not detected by the detection unit 113 is an example of the fact that the first address set is not selected by the user.

The setting unit 112 sets the address for each of the transmitting destination types configuring the selected first address set to the e-mail (ACT 5) based on the fact that the selection of the first address set is detected by the detection unit 113. In ACT 5, for example, the setting unit 112 reflects the address for each of the transmitting destination types configuring the selected first address set to the e-mail generation window 2.

The transmitting destination setting process of ACT 1 to ACT 5 described above may be repeated a plurality of times based on the input by the user with the input device 14.

According to the transmitting destination setting process, the terminal 1 can allow the display device 15 to display the one or more first address sets including the second address set so as to be selectable. The terminal 1 can set the address for each of the transmitting destination types configuring the selected first address set to the e-mail. Since the first address set is a history of transmitted e-mails, the first address set includes sorting based on the transmitting destination type and is correct for the user. Therefore, the terminal 1 can reduce input errors such as omission of necessary addresses, existence of unnecessary addresses, or errors in sorting of transmitting destination types and can reduce erroneous transmissions of the e-mail due to the input errors. The terminal 1 can shorten the work time required for the user to input the transmitting destination. The user only has to select the first address set, and thus, there is no need to input transmitting destination addresses one by one.

The detection unit 113 detects the selection of the “Transmit” key 26 by the user (ACT 6). In ACT 6, for example, the detection unit 113 detects the selection of the “Transmit” key 26 by the user after one or more times of the transmitting destination setting processes of ACT 1 to ACT 5. The transmission control unit 116 starts the e-mail transmission process based on the fact that the selection of the “Transmit” key 26 is detected by the detection unit 113. The e-mail transmission process has not been completed in ACT 7 to ACT 13 described later.

The determination unit 114 determines whether the first address set is selected based on the fact that the selection of the “Transmit” key 26 is detected by the detection unit 113 (ACT 7). In ACT 7, for example, the determination unit 114 determines whether the identification number of the selected first address set is stored in the main memory 12 or the auxiliary storage device 13. The determination unit 114 determines whether the first address set is selected based on whether the identification number of the selected first address set is stored. If the determination unit 114 determines that the first address set is selected (YES in ACT 7), the process transitions from ACT 7 to ACT 11. If the determination unit 114 determines that the first address set is not selected (NO in ACT 7), the process transitions from ACT 7 to ACT 8.

The determination unit 114 determines whether the first condition is satisfied based on the fact that the first address set is not selected (ACT 8). In ACT 8, for example, the determination unit 114 compares the second address set after the selection of the “Transmit” key 26 is detected by the detection unit 113 with the plurality of first address sets. The determination unit 114 determines whether the first condition is satisfied based on the comparison. It is noted that, in ACT 8, the determination unit 114 may determines whether the first condition is satisfied based on the fact that the selection of the “Transmit” key 26 is detected by the detection unit 113. The determination as to whether the first condition is satisfied is an example of an inquiry process.

If the determination unit 114 determines that the first condition is satisfied (YES in ACT 8), the process transitions from ACT 8 to ACT 14. If the determination unit 114 determines that the first condition is not satisfied (NO in ACT 8), the process transitions from ACT 8 to ACT 9. Subsequent processes differ depending on whether the determination unit 114 determines that the first condition is satisfied. The display control unit 111 changes whether the confirmation dialog 4 is necessary depending on whether the determination unit 114 determines that the first condition is satisfied.

The display control unit 111 allows the display device 15 to display the confirmation dialog 4 based on the fact that it is detected by the determination unit 114 that the first condition is not satisfied (ACT 9). In ACT 9, for example, the display control unit 111 allows the display device 15 to display the confirmation dialog 4 after the detection of the selection of the “Transmit” key 26 by the detection unit 113 and before the transmission of the e-mail. “After the selection of the “Transmit” key 26 is detected by the detection unit 113” is an example after the selection of the “Transmit” key 26 by the user. It is noted that the display control unit 111 allows the display device 15 not to display the confirmation dialog 4 based on the fact that it is detected by the determination unit 114 that the first condition is satisfied.

According to the present example, if the first condition is not satisfied, the terminal 1 can allow the display device 15 to display the confirmation dialog 4 as a warning to the user. Even though the second address set does not match the first address set, if the second address set includes the sorting of the transmitting destination types and is a portion of the first address set, the second address set is correct to the user. Therefore, the possibility of input error is low. On the other hand, if the second address set includes the sorting of the transmitting destination types and is not included in the first address set the second address set is new to the user. Therefore, it cannot be said that there is no possibility of input error. The terminal 1 can prompt the user to confirm the second address set before the transmission of the e-mail by displaying the confirmation dialog 4. The terminal 1 can reduce erroneous transmission of the e-mail due to the input error.

The detection unit 113 detects the selection of the “OK” key 41 by the user (ACT 10). If the detection unit 113 detects the selection of the “OK” key 41 (YES in ACT 10), the process transitions from ACT 10 to ACT 14. The fact that the selection of the “OK” key 41 is detected by the detection unit 113 is an example of the fact that the “OK” key 41 is selected by the user. If the detection unit 113 detects the selection of the “Cancel” key 42 (NO in ACT 10), the process transitions from ACT 10 to the transmitting destination setting process. The user can input to the mail generation window 2 again. The fact that the selection of the “Cancel” key 42 is detected by the detection unit 113 is an example of the fact that the “Cancel” key 42 is selected by the user.

The determination unit 114 determines whether the second condition is satisfied based on the fact that the first address set is selected (ACT 11). In ACT 11, for example, the determination unit 114 acquires the identification number of the selected first address set stored in the main memory 12 or the auxiliary storage device 13. The determination unit 114 refers to the address set database 131 and identifies the selected first address set based on the acquired identification number. The determination unit 114 compares the second address set after the selection of the “Transmit” key 26 is detected by the detection unit 113 with the selected first address set. The determination unit 114 determines whether the second condition is satisfied based on the comparison. The determination as to whether the second condition is satisfied is an example of the inquiry process.

If the determination unit 114 determines that the second condition is satisfied (YES in ACT 11), the process transitions from ACT 11 to ACT 14. If the determination unit 114 determines that the second condition is not satisfied (NO in ACT 11), the process transitions from ACT 11 to ACT 12. Subsequent processes differ depending on whether the determination unit 114 determines that the second condition is satisfied. The display control unit 111 changes the necessity/unnecessary of the confirmation dialog 5 depending on whether the determination unit 114 determines that the second condition is satisfied.

The display control unit 111 allows the display device 15 to display the confirmation dialog 5 based on the fact that it is detected by the determination unit 114 that the second condition is not satisfied (ACT 12). In ACT 12, for example, the display control unit 111 allows the display device 15 to display the confirmation dialog 5 after the detection of the selection of the “Transmit” key 26 by detection unit 113 and before the transmission of the e-mail. It is noted that the display control unit 111 allows the display device 15 not to display the confirmation dialog 5 based on the fact that it is detected by the determination unit 114 that the second condition is satisfied.

According to the present example, if the second condition is not satisfied, the terminal 1 can allow the display device 15 to display the confirmation dialog 5 as a warning to the user. If the second address matches the selected first address set and includes the sorting of the transmitting destination types, the second address set is correct to the user. Therefore, the possibility of input error is low. On the other hand, if the second address set does not match the first address set selected and includes the sorting of the transmitting destination types, the second address set is edited by the user. Therefore, it cannot be said that there is no possibility of input error such as deletion of necessary address or addition of unnecessary address. The terminal 1 can prompt the user to confirm the second address set before the transmission of the e-mail by displaying the confirmation dialog 5. The terminal 1 can reduce erroneous transmission of the e-mail due to the input error.

The detection unit 113 detects the selection of the “OK” key 51 by the user (ACT 13). If the selection of the “OK” key 51 is detected by the detection unit 113 (YES in ACT 13), the process transitions from ACT 13 to ACT 14. If the selection of the “Cancel” key 52 is not detected by the detection unit 113 (NO in ACT 13), the process transitions from ACT 13 to the transmitting destination setting process. The user can input to the mail generation window 2 again.

The transmission control unit 116 completes the e-mail transmission process (ACT 14). In ACT 14, in one example, the transmission control unit 116 completes the e-mail transmission process based on the fact that the selection of the “OK” key 41 is detected by the detection unit 113 in ACT 10. In another example, the transmission control unit 116 completes the e-mail transmission process based on the fact that it is detected by the determination unit 114 in ACT 8 that the first condition is satisfied. In yet another example, the transmission control unit 116 completes the e-mail transmission process based on the fact that it is detected by the determination unit 114 in ACT 11 that the second condition is satisfied. In yet another example, the transmission control unit 116 completes the e-mail transmission process based on the fact that the selection of the “OK” key 51 is detected by the detection unit 113 in ACT 13.

The determination unit 114 determines whether a third condition is satisfied based on the fact that the e-mail transmission process has been completed by the transmission control unit 116 (ACT 15). The third condition is that a first address set that matches the second address set exists in the plurality of first address sets. As described above, the second address set matches the first address set. In ACT 15, for example, the determination unit 114 compares the second address set set in the e-mail for which the transmission process has been completed with the plurality of first address sets. The second address set set in the e-mail the e-mail for which the transmission process has been completed corresponds to the second address set after the detection of the selection of the “Transmit” key 26 by the detection unit 113. The determination unit 114 determines whether the third condition is satisfied based on the comparison.

If the determination unit 114 determines that the third condition is satisfied (YES in ACT 15), the process ends. The fact that the determination unit 114 determines that the third condition is satisfied is an example of the fact that the third condition is satisfied. If the determination unit 114 determines that the third condition is not satisfied (NO in ACT 15), the process transitions from ACT 15 to ACT 16. The fact that the determination unit 114 determines that the third condition is not satisfied is an example of the fact that the third condition is not satisfied.

The storage control unit 115 stores a new first address set based on the fact that it is detected by the determination unit 114 that the third condition is not satisfied (ACT 16). In ACT 16, for example, the storage control unit 115 stores the second address set as the first address set in the address set database 131.

According to the present example, the terminal 1 can store a second address set that does not exist in the stored plurality of first address sets as a new first address set. The terminal 1 can increase the number of first address sets that are selection candidates which are to be displayed in the transmitting destination setting process. The terminal 1 can increase the number of first addresses which are to be compared with the second address in the inquiry process. Accordingly, the terminal 1 can reduce the input error in the transmitting destination setting process or the inquiry process and can reduce the erroneous transmission of the e-mail due to the input error. Since the terminal 1 automatically accumulates the first address set, the operation of setting the first address set by the user can be omitted.

It is noted that, in ACT 9, the display control unit 111 may allow the display device 15 to display the address different from a comparison target in the second address set in an identifiable mode. In the present example, the comparison target is one first address set out of the plurality of first address sets. For example, the comparison target is a first address set that is close to the second address set. The first address set that is close to the second address set is a first address set having the least number of different addresses in the second address set. The different addresses are excessive or deficient addresses for each transmission type in the second address set. In the present example, the comparison target can be an address set that the user has been highly likely to originally desire to set if the second address set was incorrect. The different addresses can be determined with the process of ACT 8 by the determination unit 114. The comparison target can be determined with the process of ACT 8 by the determination unit 114. The display control unit 111 allows the display device 15 to display different addresses in an identifiable mode after the detection of the selection of the “Transmit” key 26 by the detection unit 113 and before the transmission of the e-mail.

In one example, the display control unit 111 allows the display device 15 to display a notification regarding the difference. The notification regarding the difference includes a notation for allowing the different addresses to be identifiable directly or by comparing with all the addresses input in the e-mail generation window 2. The notification regarding the difference may include different addresses. Instead or altogether, the notification regarding the difference may include all the addresses for the respective transmitting destination types configuring the comparison target. The notification regarding the difference may be implemented in the confirmation dialog 4 or may be implemented in a dialog different from the confirmation dialog 4. If the notification regarding the difference is implemented in the confirmation dialog 4, the confirmation dialog 4 is also an example of the notification regarding the confirmation of the transmission of the e-mail and also an example of the notification regarding the difference.

In another example, the display control unit 111 displays different addresses in the e-mail generation window 2 in an identifiable mode. The display control unit 111 may display excessive addresses among the different addresses in a display mode different from the display mode of the non-different addresses. The display mode is, color, size, and the like, but the display mode not limited thereto. The display control unit 111 may temporarily display the deficient addresses among the different addresses by superimposing the addresses on the mail generation window 2 in a display mode different from the display mode of the non-different addresses.

According to the present example, the terminal 1 can display the address different from the comparison target in the second address set in an identifiable mode. The terminal 1 can support the user to facilitate determining whether to transmit an e-mail and modifying the second address set.

It is noted that, in ACT 12, the display control unit 111 may allow the display device 15 to display the address different from the comparison target in the second address set in an identifiable mode. In the present example, the comparison target is a first address set selected from among the selection candidate list 3. In the present example, the comparison target can be an address set that the user has been highly likely to originally desire to set if the second address set was incorrect. The different addresses can be determined with the process of ACT 11 by the determination unit 114. The display control unit 111 allows the display device 15 to display different addresses in an identifiable mode after the detection of the selection of the “Transmit” key 26 by the detection unit 113 and before the transmission of the e-mail.

In one example, the display control unit 111 allows the display device 15 to display a notification regarding the difference in the same manner as described above. The notification regarding the difference may be implemented in the confirmation dialog 5 or may be implemented in a dialog different from the confirmation dialog 5. If the notification regarding the difference is implemented in the confirmation dialog 5, the confirmation dialog 5 is also an example of the notification regarding the confirmation of the transmission of the e-mail and also an example of the notification regarding the difference. In another example, the display control unit 111 displays the different addresses in the e-mail generation window 2 in an identifiable mode similarly to the above description.

According to the present example, the terminal 1 can display an address different from the comparison target in the second address set in an identifiable mode. The terminal 1 can support the user to facilitate determining whether to transmit an e-mail and modifying the second address set.

It is noted that ACT 7 and ACT 11 to ACT 13 may be omitted. In the present example, in ACT 8, the determination unit 114 determines whether the first condition is satisfied, regardless of whether the first address set is selected in ACT 4.

It is noted that the information processing apparatus may be implemented by one device as described by exemplifying the terminal 1 or may be implemented by a system in which the functions are distributed to a plurality of devices.

It is noted that the information processing apparatus is generally transferred in a state where the program is stored in the main memory or the auxiliary storage device. However, the information processing apparatus is not limited to thereto, and the information processing apparatus may be transferred in a state where the program is not stored in the main memory or the auxiliary storage device. Here, the program transferred separately from the information processing apparatus is written to the writable storage device included in the information processing apparatus according to the operation of the user or the like. The program can be transferred by recording the program on a removable recording medium or by communicating via the network. The recording medium may be in any form as long as recording medium such as a CD-ROM or a memory card can store a program and the device can read the recording medium. The function obtained by installing or downloading the program may be one that implements the function in cooperation with an operating system (OS) or the like inside the device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a processor configured to:
receive an indication of one or more operator-entered addresses entered into an e-mail by an operator via an input device, each of the one or more operator-entered addresses including a respective transmitting destination type;
acquire one or more pre-stored address sets from a storage unit, each of the one or more pre-stored address sets including a plurality of pre-stored addresses, in response to (i) each of the one or more pre-stored address sets including a corresponding pre-stored address that matches each of the one or more operator-entered addresses and (ii) the respective transmitting destination type of each of the one or more operator-entered addresses matching the respective transmitting destination type of the corresponding pre-stored address;
display the one or more pre-stored address sets on a display device;
receive a selection of a respective set of the one or more pre-stored address sets via the input device; and
update the e-mail to include one or more of the plurality of pre-stored addresses of the respective set that are not included in the one or more operator-entered addresses.

2. The information processing apparatus of claim 1, wherein the processor is configured to receive a transmission instruction via the input device regarding a request to transmit the e-mail.

3. The information processing apparatus of claim 2, wherein the processor is configured to:
compare addresses in the e-mail at the time of the transmission instruction to the respective set that was selected;
determine that at least one address was added or removed based on the addresses in the e-mail at the time of the transmission instructions not matching the respective set;
provide a notification on the display device requesting confirmation of transmission of the e-mail; and
transmit the e-mail in response to receiving a confirmation instruction via the input device.

4. The information processing apparatus of claim 3, wherein the processor is configured to store the addresses in the storage unit as a new pre-stored address set in response to the e-mail being transmitted and the addresses in the e-mail not matching the pre-stored address sets already stored in the storage unit.

5. The information processing apparatus of claim 2, wherein the processor is configured to:
compare addresses in the e-mail at the time of the transmission instruction to the respective set that was selected;
determine that the addresses in the e-mail at the time of the transmission instructions match the respective set; and
transmit the e-mail without requiring a confirmation instruction to transmit the e-mail.

6. The information processing apparatus of claim 1, wherein the processor is configured to:
refrain from displaying any pre-stored address sets stored in the storage unit in response to (i) none of the pre-stored address sets within the storage unit including a corresponding pre-stored address that matches each of the one or more operator-entered addresses or (ii) the respective transmitting destination type of each of the one or more operator-entered addresses not matching the respective transmitting destination type of the corresponding pre-stored address.

7. The information processing apparatus of claim 6, wherein the processor is configured to:
receive a transmission instruction via the input device regarding a request to transmit the e-mail;
provide a notification on the display device requesting confirmation of transmission of the e-mail in response to not receiving a selection of a pre-stored address set prior to receiving the transmission instruction; and
transmit the e-mail to the one or more operator-entered addresses in response to receiving a confirmation instruction via the input device.

8. The information processing apparatus of claim 7, wherein the processor is configured to store the one or more operator-entered address as a new pre-stored address set in the storage unit in response to transmitting the e-mail to the one or more operator-entered addresses.

9. The information processing apparatus of claim 1, wherein the respective transmitting destination type includes a “TO” type, a “CC” type, or a “BCC” type.

10. The information processing apparatus of claim 1, further comprising the storage unit, the storage unit configured to store a plurality of address sets.

11. The information processing apparatus of claim 1, further comprising the display device.

12. The information processing apparatus of claim 1, further comprising the input device.

13. The information processing apparatus of claim 1, further comprising the input device and the display device.

14. The information processing apparatus of claim 13, wherein the input device and the display device are the same device.

15. The information processing apparatus of claim 13, wherein the input device and the display device are integrated into the same device.

16. The information processing apparatus of claim 1, wherein the one or more pre-stored address sets are displayed in a window on top of the e-mail.

17. The information processing apparatus of claim 16, wherein the one or more of the plurality of pre-stored addresses of the respective set that are not included in the one or more operator-entered addresses are shown in the window with a different appearance than the one or more of the one or more of the plurality of pre-stored addresses of the respective set that not included in the one or more operator-entered addresses.

18. The information processing apparatus of claim 17, wherein the difference in appearance includes at least one of a different color or a different size.

19. An information processing method comprising:
displaying one or more first address sets including a second address set on a display unit based on the fact that one or more first address sets including a second address set configured with addresses for respective transmitting destination types set in an e-mail before transmission exist in the plurality of first address sets configured with addresses for the respective transmitting destination types stored in a storage unit; and
setting the address for each of the transmitting destination types configuring a selected first address set to the e-mail based on the selection of the first address set from among the one or more first address sets displayed on the display unit.

20. A method comprising:
storing, by a storage unit, a plurality of address sets, each of the plurality of address sets including a plurality of pre-stored addresses and each of the plurality of pre-stored addresses including a respective transmitting destination type;
receiving, by a processor, an indication of one or more operator-entered addresses entered into an e-mail by an operator via an input device, each of the one or more operator-entered addresses including a respective transmitting destination type;
acquiring, by the processor, one or more of the plurality of pre-stored address sets from the storage unit in response to (i) each of the one or more pre-stored address sets including a corresponding pre-stored address that matches each of the one or more operator-entered addresses and (i) the respective transmitting destination type of each of the one or more operator-entered addresses matching the respective transmitting destination type of the corresponding pre-stored address;
displaying, by the processor, the one or more of the plurality of pre-stored address sets on a display device;
receiving, by the processor, a selection of a respective set of the one or more of the plurality of pre-stored address sets via the input device; and
updating, by the processor, the e-mail to include one or more of the plurality of pre-stored addresses of the respective set that are not included in the one or more operator-entered addresses.
